(19) United States
(12) Patent Application Publication
(10) Pub. No.: US 2005/0209394 A1
(43) Pub. Date: Sep. 22, 2005

(54) Tire with natural rubber rich tread and at least two additional rubber components with high reinforcing carbon blacks

(76) Inventors: Paul Harry Sandstrom, Cuyahoga Falls, OH (US); Leighton Randolph Spadone, Beachwood, OH (US); James S. Guzi, Hudson, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/058,791

(22) Filed: Feb. 16, 2005

Related U.S. Application Data
(60) Provisional application No. 60/553,700, filed on Mar. 16, 2004.

(51) Int. Cl. C08K 3/04; C08K 3/34

(52) U.S. Cl. 524/496; 524/492

(57) ABSTRACT

The invention relates to pneumatic tires with a focus on pneumatic tires primarily intended for use in off-the-road service at relatively slow vehicular speeds, and to large truck tires, aircraft tires and agricultural tires and therefor not primarily focused on, and in one aspect intended to be exclusive of, passenger tires and particularly smaller passenger tires, wherein the elastomer composition of the treads, and at least two additional components, of such tires are of natural rubber rich rubber compositions composed, based upon the elastomers of the rubber compositions, of at least 45, alternately at least 75 weight percent cis 1,4-polyisoprene natural rubber. For this invention, the natural rubber rich treads and at least two additional natural rubber rich rubber components of such tires contain rubber reinforcing carbon blacks comprised primarily of high reinforcing, small particle size, carbon blacks. Silica reinforcement can also be used in combination with the high reinforcing carbon black for the natural rubber rich tire components.

The Applicants hereby incorporate by reference prior U.S. Provisional Application Ser. No. 60/553,700, filed on Mar. 16, 2004.

### FIELD OF THE INVENTION

The invention relates to pneumatic tires with a focus on pneumatic tires primarily intended for use in off-the-road service at relatively slow vehicular speeds, and to large truck tires, aircraft tires and agricultural tires and therefor not primarily focused on, and in one aspect intended to be exclusive of, passenger tires and particularly smaller passenger tires, wherein the elastomer composition of the treads, and at least two additional components, of such tires are of natural rubber rich rubber compositions composed, based upon the elastomers of the rubber compositions, of at least 45, alternately at least 75 weight percent cis 1,4-polyisoprene natural rubber. For this invention, the natural rubber rich treads and at least two additional natural rubber rich rubber components of such tires contain rubber reinforcing carbon blacks comprised primarily of high reinforcing, small particle size, carbon blacks. Silica reinforcement can also be used in combination with the high reinforcing carbon black for the natural rubber rich tire components.

### BACKGROUND OF THE INVENTION

While natural rubber rich treads of various pneumatic tires conventionally contain carbon black reinforcement which may be composed of various rubber reinforcing carbon blacks such as, for example, high reinforcing, small size, carbon black and/or medium reinforcing, intermediate size, carbon black, other components of such large tires conventionally contain carbon black reinforcement composed of medium to low reinforcing carbon blacks.

For this invention, utilization of high reinforcing, small size, carbon blacks is seen to allow the use of lesser amounts of the carbon black in a tire component, particularly a natural rubber rich rubber composition, as compared to use of medium to low reinforcing carbon blacks while substantially maintaining significant physical properties of the respective rubber composition. This is considered herein to be particularly applicable to off-the-road, truck, aircraft and agricultural farm tires and, in general, less advantageous for, and therefore intended in general to be exclusive of, passenger tires.

Replacement of the conventionally used medium to low reinforcing carbon blacks with lower levels of the high reinforcing carbon blacks promotes a lower specific gravity, and therefore a lower weight, for the rubber composition of the component itself.

Use of lower amounts of carbon black reinforcement in a natural rubber rich composition for a respective component of a large tire can promote a more durable tire component as a result of reduced internal heat buildup within the tire component under working conditions.

In general, use of high reinforcing carbon blacks in tire components other than the tread often promotes greater internal heat generation within the tire component during the tire service when used at equivalent levels as relatively low reinforcing carbon blacks. However, when used at lower levels, similar cured rubber properties are attainable for a natural rubber rich rubber composition of a component of a large tire with a reduction in internal heat generation and buildup in the cured tire with an attendant reduction in weight and associated cost of the tire itself.

In general, large off-the-road tires conventionally use such cooler running medium to low reinforcing carbon blacks in their natural rubber rich treads intended for ground contacting, whereas heavy truck tires, in general use either or both of medium reinforcing and high reinforcing carbon blacks. In contrast, passenger tires, which have treads that are normally primarily composed of synthetic rubber and therefore are not normally natural rubber rich, conventionally use hotter running, high reinforcing carbon blacks in their tread components which provide the tread running surface with increased traction and resistance to wear.

In general, most components of both passenger and large off-the-road tires use cooler running medium to relatively low reinforcing carbon blacks for most of their components such as, for example, tire sidewalls and cord reinforced carcass plies.

However, it is envisioned herein that the high reinforcing carbon blacks be advantageously used in a natural rubber rich tread in addition to at least two other natural rubber rich tire components of such large heavy tires, particularly in a manner where the more conventional medium to low reinforcing carbon blacks are replaced with a reduced amount of the high reinforcing blacks.

It is to be appreciated that the large off-the-road tires, even operated under larger loads, are also normally operated at lower vehicular speeds. Accordingly, the internal heat buildup factor in their natural rubber rich components is normally less and therefore not of the same consideration as for synthetic rubber rich rubber components of faster running passenger tires.

The large tires contain a significant amount of carbon black reinforcement having a specific gravity of about 1.8 g/cc with a specific gravity of a associated natural rubber rich carbon black reinforced tire component typically being, for example, about 1.1 to about 1.2. Therefore, the carbon black reinforcement makes a significant contribution to the weight of such component and consequently to the overall weight of the large tire itself.

It can readily be seen that if the carbon black reinforcement content of a natural rubber rich tire component could be effectively reduced, a significant potential savings exists in a reduction of the weight of the tire and associated increase in the associated vehicular efficiency. A further significant potential tire manufacturing efficiency exists if the carbon black reinforcement for a plurality of the components of the large tire could be limited to a single carbon black instead of a plurality of different carbon blacks.

It is considered herein that such opportunities are a unique potential for a large tire with natural rubber rich components.

For this invention, then, it is proposed that a normally internal heat generating high reinforcing carbon black be used for both the tread cap and an additional plurality of natural rubber rich components of a large tire.

It is further envisioned that use of a reduced amount of a normally internal heat generating high reinforcing carbon black in the natural rubber-rich tread cap and at least two additional natural rubber-based rubber components of such heavy tires is a distinct opportunity because, for example, it envisioned that suitable significant physical properties of the natural rubber rich rubber compositions can be obtained with an associated reduced weight reduction alone which can reduce the internal heat build up of the running tire.

As a result, a reduction in the weight of the tire can promote an increased fuel economy in an associated vehicle. This is of particular importance in large truck tires.

As hereinbefore discussed, a significant result is envisioned in the use of a more unified carbon black reinforcement in a plurality of tire components to promote an economy in carbon black usage and cost savings in a tire production facility and manufacturing operation. Thus, in an ultimate view, a significant benefit arises from a potential use of a single carbon black in all of the natural rubber rich tire components.

Rubber reinforcing carbon blacks are typically categorized according to their size and structure by ASTM designations. Various rubber reinforcing carbon blacks and their ASTM designations may be found for example in The Vanderbilt Rubber Handbook (1990), Page 417.

Average particle size is one of the most distinguishing characteristics of a grade of rubber reinforcing carbon black. Electron microscopy is cumbersome and subject to sampling error for evaluating average particle size of rubber reinforcing carbon black. Instead, analytical procedures are typically used such as for example, Iodine Adsorption based, at least in part, upon the surface area per unit of weight varies inversely with its average particle size. Rubber reinforcing carbon blacks with ASTM assigned Iodine Adsorption numbers, or values, in the 100 and 200 series are considered as being very small sized carbon blacks and typically of high rubber reinforcement value and rubber reinforcing carbon blacks with ASTM assigned values in the 500 and 600 series are considered as being of a significantly larger size and typically of value for reinforcement of rubber compositions where such high degree of reinforcement is not as important as providing a rubber composition with a reduced tendency of internal heat build-up under working conditions.

Structure is an additional means of characterization of rubber reinforcing carbon blacks. Rubber reinforcing carbon blacks are aggregates of somewhat randomly fused together primary carbon black particles. Thus the structure of the resulting aggregates of rubber reinforcing carbon blacks can vary, depending somewhat on the variables of the process used for their manufacture. As a measure of such structure, an ASTM D2414 procedure for measuring absorption of dibutylphthalate (DBP) is used. ASTM assigned DBP values for rubber reinforcing carbon blacks are in terms of cc/100 g.

High reinforcing carbon blacks are typically carbon blacks having, for example, an Iodine adsorption value in a range of from about 100 to about 200 g/kg, which is indicative of their high surface area and small average particle size. Such rubber reinforcing carbon blacks also have a typical high structure as indicated by a DBP absorption value in a range of from about 100 to about 200 cc/100 g (which is indicative of their relatively high structure).

Representative of various small size, high structure rubber reinforcing carbon blacks are, for example and according to their ASTM designations, N110, N120, N121, N134, N205, N220, N231, N232, and N299.

For other natural rubber rich tire components of such tires, significantly larger sized rubber reinforcing carbon blacks are typically used to promote, for example, cooler running rubber compositions while still providing suitable rubber reinforcement. Such other tire components are, for example, outer rubber sidewall layers, tread underlying rubber base layers, rubber for cord reinforced carcass plies, rubber for cord reinforced belt plies and internal sidewall inserts including sidewall apexes. Such larger rubber reinforcing carbon blacks may have, for example, an Iodine adsorption value in a range of from about 20 about 100 g/kg (indicative of their relatively larger particle size) and a DBP absorption value in a range of from about 20 to 150 cc/100 g (indicative of their relatively lower structure). Representative of such larger size rubber reinforcing carbon blacks are, for example and according to their ASTM designations, N326, N343, N347, N375, N472, N550, N630 and N762.

An aspect of this invention is the adaptation and substitution of small average size rubber reinforcing carbon blacks in place of relatively large average particle size rubber reinforcing carbon blacks in a significant portion of the natural rubber rich tire components in addition to the tire tread itself for large, relatively slow moving tires, or heavy truck tires, with intended significantly lower heat generation and resultant heat built up during the working of the tire under typical vehicular speed operating conditions.

As hereinbefore discussed, it is therefore envisioned that a significant result of such adaptation and substitution of carbon black(s) is an appreciable reduction in weight of the respective tire due to the reduction in overall weight of the carbon black reinforcement (due to use of a less amount of the smaller average sized carbon black particles) with an attendant increase in fuel efficiency of the associated vehicle. This weight reduction is a direct result of the reduced specific gravity of the natural rubber rich rubber compositions of the tire components containing lower levels of the higher reinforcing carbon blacks. The reduced specific gravity is directly related to the carbon black having the highest density of most any, if not all, ingredients in the natural rubber rich rubber component. For example, the specific gravity of the carbon black reinforcement is about 1.8 gm/cc whereas the specific gravity of other ingredients are about 1 gm/cc or less for which it can readily be seen is a very significant difference in weight contributions to the associated natural rubber rich tire component.

In the description of this invention, the term “phr,” where used herein, and according to conventional practice, refers to “parts of a respective material per 100 parts by weight of rubber or elastomer”.

In the description of this invention, the terms “rubber” and “elastomer,” if used herein, may be used interchangeably, unless otherwise prescribed. The terms “rubber composition,” “compounded rubber” and “rubber compound,” if used herein, are used interchangeably to refer to “rubber which has been blended or mixed with various ingredients and materials” and such terms are well known to those having skill in the rubber mixing or rubber compounding art.

By the term “natural rubber rich” rubber composition, it is meant herein that the elastomers of such rubber composition are composed of at least 45, alternately at least about 75, weight percent cis 1,4-polyisoprene natural rubber.

In the description of this invention, the DBP absorption values for carbon blacks is a dibutylphthalate value expressed in terms of cc/100 grams according to ASTM D2414. The Iodine values for the carbon blacks are expressed in terms of g/kg according to ASTM D1510.

### SUMMARY AND DESCRIPTION OF THE INVENTION

In accordance with this invention, a pneumatic tire is provided which is comprised of a generally toroidal shaped carcass with an outer circumferential tread intended to be ground contacting, wherein said tread component and at least two additional tire components of said tire are comprised of natural rubber rich rubber compositions individually comprised of:
(A) 100 parts by weight of at least one diene-based elastomer comprised of at least 45, alternately at least 75, weight percent cis 1,4-polyisoprene natural rubber, and
(B) about 25 to about 100 phr reinforcing filler as:
   (1) about 10 to about 70 phr of rubber reinforcing carbon black comprised of:
      (a) from about 75 to about 100 weight percent Category A carbon black characterized by an Iodine Adsorption value (ASTM D-1510) in a range of from about 100 to about 200 g/kg and a corresponding DBP absorption value (ASTM D-2414) in a range of from about 100 to about 200 cc/100 g, and, correspondingly,
      (b) from zero to about 25 weight percent Category B carbon black characterized by having an Iodine adsorption value in a range of from about 20 to about 100 g/kg and a corresponding DBP absorption value in a range of from about 20 to about 150 cc/100 g and
   (2) from zero to about 40, alternately from about 5 to about 30, phr of synthetic amorphous precipitated silica.

In one aspect of the invention said tread component is an outer tread cap layer intended to be ground contacting of a tire tread comprised of a cap/base construction wherein said tread base layer underlies said tread cap layer.

In additional accordance with this invention, said tire is comprised of said circumferential tread of a cap/base construction, composed of an outer rubber tread cap layer intended to be ground contacting (a running surface of the tire) and an underlying rubber tread base layer, and a supporting carcass, spaced apart beads, and outer rubber sidewall layers extending from said beads to said circumferential tread, wherein said at least two additional tire components are selected from at least one of the group selected from
(A) said tread rubber base layer,
(B) a cord reinforced rubber carcass ply of said tire carcass,
(C) a cord reinforced rubber belt ply of said tire carcass,
(D) an outer rubber sidewall layer,
(E) a rubber apex positioned adjacent to a said bead and
(F) said sidewall rubber insert positioned within a tire sidewall and spaced apart from a said bead and wherein said components are individually comprised of said natural rubber rich compositions.

In additional accordance with this invention, said Category A carbon blacks are selected from N110, N120, N121, N134, N205, N220, N231, N232, and N299 ASTM designated rubber reinforcing carbon blacks and said Category B carbon blacks are selected from N326, N343, N347, N375, N472, N550, N630 and N762 rubber reinforcing carbon blacks.

In an additional aspect of the invention, said tire tread component is an outer tread cap layer intended to be ground contacting of a tread having a cap/base configuration where said tread base layer underlies the outer tread cap layer and wherein said additional tire components are an outer sidewall rubber layer together with at least one of a cord reinforced carcass ply, a cord reinforced circumferential belt ply, a sidewall apex, a sidewall insert individually spaced apart from and positioned axially outward from a tire beads and a tire tread rubber base layer of a tread having a cap/base configuration.

A significant aspect of the present invention is the primary use of natural rubber in the various tire components combined with the use of the high reinforcing carbon blacks. This is considered significant because the desired physical properties of high stiffness (e.g. hot hardness) and high rebound with good tear strength and abrasion resistance are achievable with the use of high levels of natural rubber in the tire components.

If desired, one or more of such natural rubber-rich rubber compositions of said tire components may contain from 10 to about 40 phr of silica-containing carbon black composed of carbon black containing domains of silica on its surface wherein said silica domains contain hydroxyl groups (e.g. silanol groups) on their surfaces. Such silica-containing carbon blacks may be prepared, for example, by co-fuming carbon and silica.

### BRIEF DESCRIPTION OF THE ACCOMPANYING DRAWING

The accompanying drawings are presented in order to further describe the invention. In particular, FIG. 1 as a graphical presentation of the aforesaid Category A and Category B carbon blacks in terms of their approximate DBP and Iodine values in order to more clearly appreciate their spaced apart differentiated characterizations.

FIG. 2 is a partial cross-sectional view of a tire which is presented to show the respective rubber tire components for carbon black reinforcement.

### ACCOMPANVING DRAWINGS

FIG. 1 presents the categorized carbon blacks with a reference to their DBP absorption values (y-axis) and Iodine values x-axis).

Box A presents the small size Category A carbon blacks having DBP absorption values in a range from 100 to 200 cc/100 gm and Iodine values in a range of from 100 to 200 g/kg.

Box B present the significantly larger size Category B carbon blacks having DBP absorption values in a range from 20 to 150 cc/100 gm and Iodine values in a range of from 20 to 100 g/kg,

Box A contains ASTM designated N100 and N200 series carbon blacks. Representative examples of such carbon blacks are N110, N120, N121, N134 and N234 rubber reinforcing carbon blacks Box B contains N300, N500, N600 and N800 series carbon blacks. Representative examples of such carbon blacks are the N326, N330, N347, N660, N550 and N880 rubber reinforcing carbon blacks.

It can readily be seen from FIG. 1 that the categorized rubber reinforcing carbon blacks of Category A are clearly and distinctly spaced apart from those of Category B.

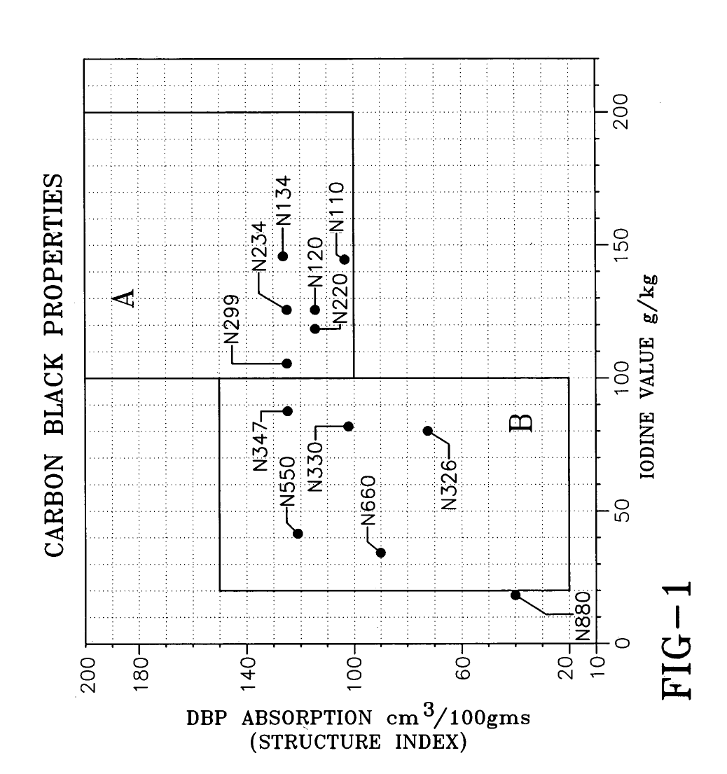

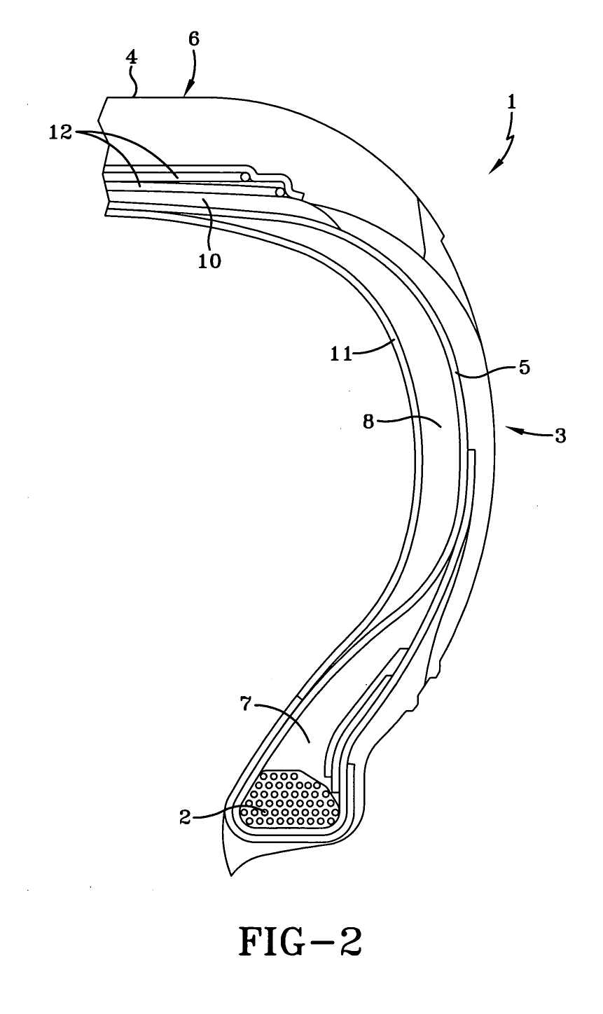

FIG. 2 depicts a large tire (1) with a tread (6) of cap/base construction composed of a tread cap rubber layer with a running surface (4) and an underlying tread base rubber layer. The tire (1) contains two spaced apart beads with one bead (2) being shown, a cord reinforced carcass ply (12) extending from bead to bead, a plurality of circumferential cord reinforced belt plies (12) underlying said tread base rubber layer (not numbered), an outer sidewall rubber layer (3), an internal sidewall apex (7) adjacent to said tire bead (2), an internal sidewall rubber insert (8) spaced apart from and positionally axially outward from said bead (2), an innerliner (11) and an optional rubber layer (10).

In FIG. 2, the said tread cap layer and three additional tire components, in particular the outer sidewall rubber layer (3) and two additional tire components, namely a cord reinforced circumferential belt ply (5) and an internal sidewall apex (8), are comprised of at least 75 phr of cis 1,4-polyisoprene natural rubber and up to 25 phr of cis 1,4-polybutadiene rubber which contain 30 to 60 phr of a high rubber reinforcing, small particle sized carbon black as N220 carbon black, which is an aforesaid Category A carbon black.

In the practice of this invention, as hereinbefore pointed out, the rubber compositions containing the high reinforcing carbon black are to be comprised of at least one diene-based elastomer and the elastomers of the rubber composition are to be composed of at least 45 weight percent cis 1,4-polyisoprene natural rubber. The synthetic diene-based elastomers, other than, or in addition to, the aforesaid cis 1,4-polyisoprene natural rubber, are typically selected from homopolymers and copolymers of conjugated dienes (e.g. isoprene and/or 1,3-butadiene) and copolymers of a vinyl aromatic compound such as, for example, styrene and alpha-methylstyrene (preferably styrene) with at least conjugated diene (e.g. isoprene and/or 1,3-butadiene).

Representative of such synthetic elastomers, or rubbers, are, for example, elastomers selected from at least one of cis 1,4-polyisoprene rubber, 3,4-polyisoprene rubber, styrene/butadiene copolymer rubber, isoprene/butadiene copolymer rubber, styrene/isoprene copolymer rubber, styrene/isoprene/butadiene terpolymer rubber, cis 1,4-polybutadiene rubber, trans 1,4-polybutadiene rubber (having a trans 1,4-content in a range of from about 70 to about 95 percent), low vinyl polybutadiene rubber (10 to 30 percent vinyl), high vinyl polybutadiene rubber (30 to 90 percent vinyl).

The natural rubber rich compositions which contain silica, particularly a precipitated silica, may also contain a coupling agent for said silica which contains a moiety reactive with hydroxyl groups (e.g. silanol groups) on the surface of the silica and another moiety interactive with said diene-based elastomers.

Representative of such coupling agents are, for example, bis(3-trialkoxysilylalkyl) polysulfides which contain an average of from 2 to 4 connecting sulfur atoms in its polysulfidic bridge, preferably an average of from 2 to about 2.6 or an average of from about 3.4 to about 4 connecting sulfur atoms. Such coupling agent may be, for example, a bis(3-triethoxysilylpropyl) polysulfide. Additional representative coupling agents may be, for example, organoalkoxymercaptosilanes.

Use of synthetic amorphous silicas, particularly precipitated silicas, in rubber compositions for various tire components is well known to those having skill in such art. Representative of such precipitated silicas are, for example, HiSil™ 210 and 243 from the PPG Industries company, VN3™ from the Degussa Company and various precipitated silicas from the J.M Huber company and the Rhodia company.

It is readily understood by those having skill in the art that the rubber composition would be compounded by methods generally known in the rubber compounding art, such as mixing the various sulfur-vulcanizable constituent rubbers with various commonly used additive materials. Such materials include for example, and in addition to the aforesaid carbon black combinations, curing aids, such as sulfur, activators, retarders and accelerators, processing additives, such as oils, resins including tackifying resins, coupling agent, and plasticizers, fillers, pigments, fatty acid, zinc oxide, waxes, antioxidants and antiozonants and peptizing agents. As known to those skilled in the art, depending on the intended use of the sulfur-vulcanizable and sulfur-vulcanized material (rubbers), the additives mentioned above are selected and commonly used in conventional amounts.

The composition of the present invention may contain conventional amounts of known rubber chemicals.

Typical amounts of tackifier resins, if used, may comprise about 0.5 to about 10 phr, usually about 1 to about 5 phr. Typical amounts of processing aids comprise about 1 to about 50 phr. Such processing aids can include, for example, aromatic, napthenic, and/or paraffinic processing oils. Typical amounts of antioxidants comprise about 1 to about 5 phr. Representative antioxidants may be, for example, diphenyl-p-phenylenediamine and others such as, for example, those disclosed in The Vanderbilt Rubber Handbook (1978), Pages 344 through 346. Typical amounts of antiozonants comprise about 1 to 5 phr. Typical amounts of fatty acids, if used, which are usually comprised primarily of stearic acid, comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

The vulcanization of the rubber composition is conducted in the presence of a sulfur-vulcanizing agent. Examples of suitable sulfur-vulcanizing agents include elemental sulfur (free sulfur) or sulfur-donating vulcanizing agents, for example, an amine disulfide, polymeric polysulfide or sulfur olefin adducts. Preferably, the sulfur-vulcanizing agent is elemental sulfur. As known to those skilled in the art, sulfur-vulcanizing agents are used in an amount ranging from about 0.5 to about 4 phr, or even, in some circumstances, up to about 8 phr, with a range of from about 1.5 to about 2.5, sometimes from about 2 to about 2.5, being preferred.

Accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging from about 0.5 to about 4, preferably about 0.8 to about 2, phr. In another embodiment, combinations of a primary and a secondary accelerator might be used with the secondary accelerator being used in amounts of about 0.05 to about 5 phr in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The presence and relative amounts of most of the above additives are not considered to be an aspect of the present invention which is more primarily directed to the utilization of the aforesaid combinations of definitive Categories of carbon blacks for the respective tire components.

The rubber composition may be and is preferably prepared by thermomechanically working and mixing the diene-based rubber, carbon blacks and other rubber compounding ingredients, exclusive of the rubber curatives, in at least one sequential mixing step with at least one mechanical mixer, usually referred to as “non-productive” mix stage(s), to a temperature which may be in a range of, for example, about 160° C. to about 190° for a sufficient duration of time, which may be, for example, within about 4 to about 8 minutes, followed by a final mix stage in which the curatives, such as sulfur and accelerators, are added and mixed therewith which may be, for example, about 1 to about 4 minutes to a temperature which may be, for example, within a range of about 90° C. to about 125° C. The terms “non-productive” and “productive” mix stages are well known to those having skill in the rubber mixing art.

It is to be appreciated that the rubber composition is conventionally cooled to a temperature below about 40° C. between the aforesaid mix stages.

It is to be further appreciated that the aforesaid duration of time for the required temperature maintenance for the mixing process(es) during the non-productive mix stages can be accomplished, for example, by
(A) adjusting the motor speed of the mixer, namely reducing the motor speed after the desired temperature of the rubber composition is reached, in a variable speed mixer or by
(B) utilizing two or more mix stages sufficient to satisfy the duration requirement for the aforesaid maximum mixing temperature maintenance.

Vulcanization of the rubber composition of the present invention is generally carried out at conventional temperatures which may range, for example, from about 100° C. to about 200° C. Usually preferably, the vulcanization is conducted at temperatures ranging from 110° C. to 180° C. Any of the usual vulcanization processes may be used such as heating in a press or mold, heating with superheated steam or hot air or in a salt bath.

Upon vulcanization of the sulfur-vulcanized composition, the rubber composition of this invention can be used for various purposes. For example, the sulfur-vulcanized rubber composition may be in the form of a tread for a pneumatic tire which is the subject of this invention. Such tires can be built, shaped, molded and cured by various methods which are known and will be readily apparent to those having skill in such art.

The invention may be better understood by reference to the following examples in which the parts and percentages are by weight unless otherwise indicated.

### EXAMPLE I

Natural rubber based rubber compositions are prepared which are individually reinforced with a precipitated silica and large sized Category B rubber reinforcing carbon black and small sized Category A reinforcing carbon black.

Control Sample A contains a relatively large sized Category B rubber reinforcing carbon black as ASTM designated N550.

Control Sample B contains a relatively medium particle sized Category B rubber reinforcing carbon black as ASTM designated N347.

Sample C and Sample D contain significantly lesser amounts, namely 20 and 15 phr respectively, of a relatively small sized Category A rubber reinforcing carbon black as ASTM designated N220.

The compositions were prepared by mixing the ingredients in several stages, namely, one non-productive stage (without the curatives, namely the sulfur and accelerators) followed by a productive mix stage (in which the curatives are added), then the resulting composition was cured under conditions of elevated pressure and temperature.

For the non-productive mixing stage, the ingredients are mixed in an internal rubber mixer for about 4 minutes to a temperature of about 160° C. following which the rubber composition is removed from the mixer, roll milled, sheeted out and allowed to cool to a temperature below 40° C.

In a subsequent productive mixing stage, the curatives are mixed with the rubber composition in an internal rubber mixer for about 2 minutes to a temperature of about 110° C. following which the rubber composition is removed from the mixer, roll milled, sheeted out and allowed to cool to a temperature below 40° C.

The rubber compositions are illustrated in the following Table 1.

TABLE 1

| | Control | Control | | |
|---|---|---|---|---|
| | Sample | Sample | Sample | Sample |
| | A | B | C | D |
| Non-Productive Mixing | | | | |
| Natural rubber¹ | 100 | 100 | 100 | 100 |
| Category (B) carbon black² | 40 | 0 | 0 | 0 |
| Category (B) carbon black³ | 0 | 30 | 0 | 0 |
| Category (A) carbon black⁴ | 0 | 0 | 20 | 15 |
| Silica⁵ | 20 | 20 | 20 | 20 |
| Processing oil, wax and | 9 | 9 | 9 | 9 |
| fatty acid⁶ | | | | |
| Zinc oxide | 4 | 4 | 4 | 4 |
| Antidegradants, | 4 | 4 | 4 | 4 |
| amine based | | | | |
| Coupling agent⁷ | 2 | 2 | 2 | 2 |
| Resorcinol | 1 | 1 | 1 | 1 |
| Hexamethylenetetramine | 1 | 1 | 1 | 1 |
| Productive Mixing | | | | |
| Sulfur | 1.5 | 1.5 | 1.5 | 1.5 |
| Accelerator(s)⁸ | 1 | 1 | 1 | 1 |

¹Cis 1,4-polyisoprene natural rubber (TSR20)
²N550 medium to low reinforcing carbon black having an Iodine value (ASTM D1510) of about 44 g/kg and a dibutyl phthalate (DBP) value (ASTM D2414) of about 122 cc/100 g
³N347 medium reinforcing carbon black having an Iodine value of about 91 g/kg and a DBP value of about 125 cc/100 g and thus within the Category B box of FIG. 1 and outside the Category A box of FIG. 1
⁴N220 high reinforcing carbon black having an Iodine value of about 123 g/kg and a DBP value of about 115 cc/100 g and thus within the Category A box of FIG. 1 of the drawings
⁵Synthetic, amorphous precipitated silica as HiSil ™ 243 LD from PPG Industries Company
⁶Rubber processing oil and microcrystalline wax as processing aids and fatty acid as primarily stearic acid
⁷Composite of a bis(3-triethoxysilylpropyl) tetrasulfide having an average in a range of about 3.4 to about 3.6 connecting sulfur atoms in its polysulfidic bridge and carbon in a 50/50 weight obtained as X50S from the Degussa company, thus 50 percent active, and reported in the Table as the composite.
⁸Sulfenamide type(s)

Various physical properties of the Samples are reported in the following Table 2. Where the physical properties are for cured rubber properties, the respective Samples were cured at a temperature of about 125° C. for about 270 minutes.

TABLE 2

| | Control | Control | | |
|---|---|---|---|---|
| | Sample | Sample | Sample | Sample |
| | A | B | C | D |
| Category B, | 40 | 0 | 0 | 0 |
| N550 carbon black | | | | |
| Category B, | 0 | 30 | 0 | 0 |
| N347 carbon black | | | | |
| Category A, | 0 | 0 | 20 | 15 |
| N220 carbon black | | | | |
| Stress-strain | | | | |
| Ultimate tensile | 21.7 | 24.6 | 26.9 | 26.5 |
| strength (MPa) | | | | |
| Ultimate elongation | 429 | 474 | 525 | 538 |
| at break (%) | | | | |
| 300% (ring) modulus | 15.6 | 14.3 | 11.7 | 10.3 |
| (MPa) | | | | |
| Hot rebound, | 73 | 72 | 76 | 79 |
| 100° C., (%) | | | | |
| Hardness (Shore A), | 62 | 62 | 60 | 57 |
| 100° C. | | | | |
| Tear strength, | 171 | 248 | 178 | 199 |
| 95° C., Newtons | | | | |
| DIN abrasion, | 128 | 112 | 120 | 116 |
| relative vol. loss, | | | | |
| Specific gravity (g/cc) | 1.147 | 1.121 | 1.096 | 1.086 |

The ultimate tensile strength, ultimate elongation, 300 percent ring modulus, Shore A hardness (100° C.) methods of rubber characterization are well known to those having skill in such art.

The tear strength is obtained by a peel strength adhesion test between two layers of the respective Sample to determine interfacial adhesion between the two layers. In particular, such interfacial adhesion is determined by pulling one rubber composition layer away from the other at a right angle to the untorn test specimen with the two ends of the rubber compositions being pulled apart at a 180° angle to each other using an Instron instrument. The area of contact at the interface between the rubber samples is facilitated by placement of a Mylar™ film between the samples with a cut-out window in the film to enable the two rubber samples to contact each other following which the samples are vulcanized together and the resultant composite of the two rubber compositions used for the peel strength test.

The DIN abrasion test (DIN 53516) is a measure of abrasion resistance using a Zwick drum abrasion unit, model 6102 with 2.5 Newtons force. The DIN abrasion results are reported as relative values to a control rubber composition used by the laboratory. The DIN abrasion test is well known to those skilled in such art. A higher value is indicative of a larger amount of rubber removed by abrasion and, thus, a greater amount of wear for the rubber sample.

The Specific Gravity is reduced by the use of the lower amounts of the higher reinforcing carbon black. Sample C shows a 4.5 percent reduction as compared to Control Sample A and Sample D shows a 5.3 percent reduction as compared to Control Sample A.

It can be seen from Table 2 that rebound values are increased, whereas tear strength and abrasion resistance values for Samples C and D are comparable to those of Control Sample A. This is considered herein as being significant because the reduction in the specific gravity of the Samples C and D, as compared to Control Sample A promotes a similar weight reduction in a respective component of a cured tire without a significant loss in the indicated cured rubber properties.

### EXAMPLE II

Natural rubber based rubber compositions are prepared which are individually reinforced with a precipitated silica and large sized Category B rubber reinforcing carbon black and small sized Category A reinforcing carbon black.

Control Sample E contains a relatively large sized Category B rubber reinforcing carbon black as ASTM designated N347.

Sample F and Sample G contain significantly lesser amounts, namely 25 and 20 phr respectively, of a relatively small sized Category A rubber reinforcing carbon black as ASTM designated N134.

The compositions were prepared by mixing the ingredients in several stages, namely, one non-productive stage (without the curatives, namely the sulfur and accelerators) followed by a productive mix stage (in which the curatives are added), then the resulting composition was cured under conditions of elevated pressure and temperature.

For the non-productive mixing stage, the ingredients are mixed in an internal rubber mixer for about 4 minutes to a temperature of about 160° C. following which the rubber composition is removed from the mixer, roll milled, sheeted out and allowed to cool to a temperature below 40° C.

In a subsequent productive mixing stage, the curatives are mixed with the rubber composition in an internal rubber mixer for about 2 minutes to a temperature of about 110° C. following which the rubber composition is removed from the mixer, roll milled, sheeted out and allowed to cool to a temperature below 40° C.

The ingredients and their amounts for the respective rubber compositions are the same as those of Table 1 except for the carbon blacks. The rubber compositions for the respective Samples are shown in the following Table 3.

TABLE 3

| | Control | | |
|---|---|---|---|
| | Sample E | Sample F | Sample G |
| Non-Productive Mixing | | | |
| Natural rubber | 100 | 100 | 100 |
| Category (B) carbon black¹ | 30 | 0 | 0 |
| Category (A) carbon black² | 0 | 25 | 20 |
| Silica | 20 | 20 | 20 |
| Processing oil, wax and fatty acid | 9 | 9 | 9 |
| Zinc oxide | 4 | 4 | 4 |
| Antidegradants, amine based | 4 | 4 | 4 |
| Coupling agent | 2 | 2 | 2 |
| Resorcinol | 1 | 1 | 1 |
| Hexamethylenetetramine | 1 | 1 | 1 |
| Productive Mixing | | | |
| Sulfur | 1.5 | 1.5 | 1.5 |
| Accelerator(s) | 1 | 1 | 1 |

¹N347 medium reinforcing carbon black having an Iodine value of about 91 g/kg and a DBP value of about 125 cc/100 g and thus within the Category B box in FIG. 1 and outside the Category A box in FIG. 1 of the drawings
²N134 high reinforcing carbon black having an Iodine value of about 142 g/kg and a DBP value of about 127 cc/100 g, and thus within the Category A box in FIG. 1 of the drawings.

Various physical properties of the Samples are reported in the following Table 4. Where the physical properties are for cured rubber properties, the respective Samples were cured at a temperature of about 125° C. for about 270 minutes.

TABLE 4

| | Control | | |
|---|---|---|---|
| | Sample E | Sample F | Sample G |
| Category B, N347 carbon black | 30 | 0 | 0 |
| Category A, N134 carbon black | 0 | 25 | 20 |
| Stress-strain | | | |
| Ultimate tensile strength (MPa) | 22.9 | 24.8 | 25.4 |
| Ultimate elongation at break (%) | 483 | 545 | 559 |
| 300% (ring) modulus (MPa) | 12.5 | 10.2 | 9.4 |
| Hot rebound, 100° C., (%) | 67 | 67 | 73 |
| Hardness (Shore A), 100° C. | 62 | 62 | 59 |
| Tear strength, 95° C., Newtons | 236 | 248 | 233 |
| DIN abrasion, relative vol. loss | 133 | 139 | 140 |
| Specific gravity (gm/cc) | 1.122 | 1.108 | 1.096 |

It can be seen from Table 4 that that the specific gravity of Sample F is 1.3 percent lower than the specific gravity of Control Sample E and the specific gravity of Sample G is 2.3 percent lower than the specific gravity of Control Sample E.

This is considered herein to be significant because a respective cured rubber component of such rubber compositions for a tire would show a similar reduction in weight.

It can also be seen from Table 4 that that the indicated cured rubber physical properties of rebound, tear strength and abrasion resistance for Samples F and G are similar and not significantly different from those of Control Sample E.

This is considered herein to be significant because a tire of lower weight can be prepared with such physical properties that may be substantially the same or even improved.

While certain representative embodiments and details have been shown for the purpose of illustrating the invention, it will be apparent to those skilled in this art that various changes and modifications may be made therein without departing from the spirit or scope of the invention.

1. A pneumatic tire comprised of a generally toroidal shaped carcass with an outer circumferential tread component intended to be ground contacting,
wherein said tread component and at least two additional tire components of said tire are comprised of natural rubber rich rubber compositions individually comprised of:
(A) 100 parts by weight of at least one diene-based elastomer comprised of at least 45 weight percent cis 1,4-polyisoprene natural rubber, and (B) about 25 to about 100 phr reinforcing filler as:
(1) about 10 to about 70 phr of rubber reinforcing carbon black comprised of:
(a) from about 75 to about 100 weight percent Category A carbon black characterized by an Iodine Adsorption value (ASTM D-1510) in a range of from about 100 to about 200 g/kg and a corresponding DBP absorption value (ASTM D-2414) in a range of from about 100 to about 200 cc/100 g, and, correspondingly,
(b) from zero to about 25 weight percent Category B carbon black characterized by having an Iodine adsorption value in a range of from about 20 to about 100 g/kg and a corresponding DBP absorption value in a range of from about 20 to about 150 cc/100 g and
(2) from zero to about 40 phr of synthetic amorphous precipitated silica.

2. The tire of claim 1 wherein said tire is selected from at least one of off-the-road, truck, aircraft and agricultural farm tires exclusive of passenger tires.

3. The tire of claim 1 wherein said tread component and at least one of said two additional tire components of said tire are comprised of natural rubber rich rubber compositions which contain from about 10 to about 40 phr of precipitated silica.

4. The tire of claim 1 wherein said tread component is an outer tread cap layer intended to be ground contacting of a tire tread comprised of a cap/base construction wherein said tread base layer underlies said tread cap layer.

5. The tire of claim 4 wherein said tire is comprised of said circumferential tread, and a supporting carcass, spaced apart beads, and outer rubber sidewall layers extending from said beads to said circumferential tread, wherein said at least two additional tire components are selected from at least one of the group selected from
(A) said tread rubber base layer,
(B) a cord reinforced rubber carcass ply of said tire carcass,
(C) a cord reinforced rubber belt ply of said tire carcass,
(D) an outer rubber sidewall layer,
(E) a rubber apex positioned adjacent to a said bead and
(F) said sidewall rubber insert positioned within a tire sidewall and spaced apart from a said bead and wherein said components are individually comprised of said natural rubber rich compositions.

6. The tire of claim 1 wherein said tire tread component is an outer tread cap layer intended to be ground contacting of a tread having a cap/base configuration where said tread base layer underlies the outer tread cap layer and wherein said additional tire components are an outer sidewall rubber layer together with at least one of a cord reinforced carcass ply, a cord reinforced circumferential belt ply, a sidewall apex, a sidewall insert individually spaced apart from and positioned axially outward from a tire beads and a tire tread rubber base layer of a tread having a cap/base configuration.

7. The tire of claim 1 wherein said Category A carbon blacks are selected from N110, N120, N121, N134, N205, N220, N231, N232, and N299 ASTM designated rubber reinforcing carbon blacks and said Category B carbon blacks are selected from N326, N343, N347, N375, N472, N550, N630 and N762 rubber reinforcing carbon blacks.

8. The tire of claim 1 wherein said natural rubber-rich rubber composition of at least one of said tire components additionally contains from about 10 to about 40 phr of silica-containing carbon black which contains domains of silica on its surface wherein said silica domains contain hydroxyl groups their surfaces.

9. The tire of claim 1 wherein said diene-based elastomer other than said cis 1,4-polyisoprene natural rubber is a synthetic elastomer selected from polymers of isoprene and/or 1,3-butadiene and copolymers of styrene with at least one of isoprene and 1,3-butadiene.

10. The tire of claim 9 wherein said synthetic diene-based elastomers are selected from at least one of cis 1,4-polyisoprene rubber, 3,4-polyisoprene rubber, styrene/butadiene copolymer rubber, isoprene/butadiene copolymer rubber, styrene/isoprene copolymer rubber, styrene/isoprene/butadiene terpolymer rubber, cis 1,4-polybutadiene rubber, trans 1,4-polybutadiene rubber, low vinyl polybutadiene rubber (10 to 30 percent vinyl content), high vinyl polybutadiene rubber (30 to 90 percent vinyl content).

11. The tire of claim 1 wherein said natural rubber rich composition which contains said silica also contain a coupling agent for said silica which contains a moiety reactive with hydroxyl groups on the surface of said silica and another moiety interactive with at least one of said diene-based elastomers.

12. The tire of claim 2 wherein said natural rubber rich composition which contains said silica also contain a coupling agent for said silica which contains a moiety reactive with hydroxyl groups on the surface of said silica and another moiety interactive with at least one of said diene-based elastomers.

13. The tire of claim 12 wherein said coupling agents is selected from bis(3-trialkoxysilylalkyl) polysulfides which contain an average of from 2 to 4 connecting sulfur atoms in its polysulfidic bridge and organoalkoxymercaptosilanes.

14. The tire of claim 4 wherein said tire is comprised of said tread of a cap/base construction, two spaced apart beads, at least one cord reinforced rubber carcass ply component extending from bead-to-bead, and rubber sidewalls containing an outer rubber sidewall layer individually positioned axially outward of at least one carcass ply component and individually extending from a bead to said tread component, wherein said tire sidewalls contain a rubber sidewall insert in a form of a sidewall apex individually positioned within a sidewall adjacent to a tire bead and optionally contains a rubber sidewall insert positioned within a sidewall and spaced apart and axially outward from a tire bead.

15. The tire of claim 1 wherein the carbon black reinforcement of said tread and at least two tire components is a Category A carbon black.

16. The tire of claim 2 wherein the carbon black reinforcement of said tread and at least two tire components is a Category A carbon black.
